(19) United States
(12) Patent Application Publication
(10) Pub. No.: US 2021/0080658 A1
(43) Pub. Date: Mar. 18, 2021

(54) FIBER OPTIC CONNECTOR DUST CAP AND RELATED METHOD

(71) Applicant: CORNING RESEARCH & DEVELOPMENT CORPORATION, Corning, NY (US)

(72) Inventors: Martin Hempstead, Painted Post, NY (US); Wolf Peter Kluwe, Hagen (DE); Eric Stephan ten Have, Berlin (DE)

(21) Appl. No.: 16/568,769

(22) Filed: Sep. 12, 2019

(51) Int. Cl. G02B 6/38; G02B 6/44

(52) U.S. Cl. CPC G02B 6/3849; G02B 6/325; G02B 6/4405; G02B 6/4442

(57) ABSTRACT

A fiber optic dust cap is provided for a fiber optic connector having a connector housing and a ferrule extending therefrom and terminating at a ferrule end face. The fiber optic dust cap includes a hollow body including a front end, a rear end, and, a bore extending therebetween. At least a first portion of the bore extends along a longitudinal axis and is configured to receive the connector housing, and at least a second portion of the bore is configured to be radially spaced apart from the ferrule. The fiber optic dust cap also includes a transparent window positioned over the bore and configured to be longitudinally spaced apart from the ferrule when the connector housing is received by at least the first portion of the bore. A method of inspecting a ferrule end face through the dust cap is also disclosed.

### TECHNICAL FIELD

This disclosure relates generally to inspection of fiber optic connectors for contaminants, and more particularly to a dust cap for a fiber optic connector and for allowing inspection of an end face of the fiber optic connector's ferrule through the dust cap.

### BACKGROUND

Optical fibers are useful in a wide variety of applications, including the telecommunications industry for voice, video, and data transmissions. Benefits of optical fiber include extremely wide bandwidth and low noise operation. In a telecommunications system that uses optical fibers, there are typically many locations where fiber optic cables carrying the optical fibers connect to equipment or other fiber optic cables. To conveniently provide these connections, fiber optic connectors are often provided on the ends of fiber optic cables.

A fiber optic connector typically includes a ferrule with one or more bores that receive one or more optical fibers. A housing that surrounds at least a portion of the ferrule defines features for mechanically retaining the fiber optic connector with another component (e.g. an adapter), which may include features for aligning the ferrule with a mating ferrule (e.g., from another fiber optic connector). Thus, when the housing of the fiber optic connector is mated with the other component, the optical fiber(s) in the ferrule can be held in alignment with the optical fiber(s) of the mating ferrule to establish an optical connection.

At interconnections between fiber optic connectors, light exiting each optical fiber of a first fiber optic connector (of a first fiber optic cable) is introduced into a corresponding optical fiber within an adjacent, second fiber optic connector (of a second fiber optic cable). The light travels in respective cores of the optical fibers. If optical fiber cores at an interconnection between first and second optical fibers are misaligned, then transmission of a fraction of an optical signal from the core of the first optical fiber to the core of the second optical fiber may be inhibited, resulting in signal degradation at the interconnection. Furthermore, and more salient to the present disclosure, if contamination such as one or more pieces of debris is present on an end face of the ferrule of either of the fiber optic connectors that terminate the optical fibers, then transmission of optical signals from the core of the first optical fiber to the core of the second optical fiber optic may be inhibited. Unlike in conductive wire cable connectors, dust, dirt, and other contaminants are a particular problem in optical connections because they affect the passage of light from one fiber to another, and signals borne by the light may be poorly transmitted, or not transmitted at all. Ferrule end faces of fiber optic connectors must therefore be kept clean to ensure long life and to minimize transmission loss and optical return loss at connection points.

To that end, a dust cap is typically coupled to the ferrule of each fiber optic connector in an effort to preserve the cleanliness of the end face until the fiber optic connector is mated with another connector. For example, the manufacturer of the fiber optic connector may conduct an initial cleaning and inspection of the ferrule end face, and immediately thereafter couple the dust cap to the ferrule. Conventional cleaning systems may include clickers, wipes, or sprays of air and solvent to clean the ferrule end face, while conventional inspection systems may include image-based inspection systems configured to visualize the ferrule end face via optical microscopy.

In any event, the customer may subsequently remove the dust cap to conduct a further cleaning and/or inspection of the ferrule end face for contamination prior to installation. In many cases, the cleaning and/or inspection of the ferrule end face performed by the customer is counterproductive and may actually introduce additional contamination to the ferrule end face. In this regard, the removal of the dust cap from the ferrule exposes the ferrule end face to potential contamination during handling of the connector. Moreover, the cleaning of the ferrule end face by the customer may introduce additional contamination via the cleaning material itself, and the inspection of the ferrule end face by the customer may introduce additional contamination via cross-contamination at the fixture of the inspection system.

In some cases, the coupling of the dust cap to the ferrule may introduce additional contamination to the ferrule end face. For example, the contact between the dust cap and the side(s) of the ferrule increase the risk of the dust cap also contacting and contaminating the ferrule end face. The contact between the dust cap and the side(s) of the ferrule may also introduce contamination to the side(s) of the ferrule, which may subsequently travel toward and onto the end face of the ferrule. In addition, the relative movement of the dust cap along the ferrule during coupling or removal of the dust cap may create static electric charges that may move or attract contamination, and/or may create contamination through chafing of the cap material onto the ferrule.

### SUMMARY

In one embodiment, a fiber optic dust cap is provided for a fiber optic connector having a connector housing and a ferrule extending therefrom and terminating at a ferrule end face. The fiber optic dust cap includes a hollow body including a front end and a rear end and defining a bore extending therebetween. At least a first portion of the bore extends along a longitudinal axis and is configured to receive the connector housing and at least a second portion of the bore is configured to be radially spaced apart from the ferrule when the connector housing is received by at least the first portion of the bore. The fiber optic dust cap also includes a transparent window positioned over the bore and configured to be longitudinally spaced apart from the ferrule when the connector housing is received by at least the first portion of the bore.

The transparent window may define a plane. In one embodiment, the plane defined by the transparent window is perpendicular to the longitudinal axis. For example, the transparent window may be centered relative to the longitudinal axis such that the transparent window is coaxial with at least the first portion of the bore. Alternatively, the transparent window may be laterally offset from the longitudinal axis. In another embodiment, the plane defined by the transparent window is oblique to the longitudinal axis to define an angular offset of the transparent window. In addition or alternatively, the plane defined by the transparent window may be configured to be parallel to a plane defined by the ferrule end face when the connector housing is received by at least the first portion of the bore. In another embodiment, the plane defined by the transparent window is configured to be oblique to a plane defined by the ferrule end face when the connector housing is received by at least the first portion of the bore.

The first portion of the bore may have a first cross dimension and the second portion of the bore may have a second cross dimension less than the first cross dimension such that a shoulder is defined between the first and second portions of the bore, and the shoulder may be configured to mechanically engage the connector housing to define a seated position of the fiber optic dust cap on the fiber optic connector. In one embodiment, the transparent window is constructed of at least one of glass or plastic. In addition or alternatively, the fiber optic dust cap may include at least one auxiliary transparent or translucent feature for allowing illumination of the ferrule end face therethrough. For example, the at least one auxiliary transparent or translucent feature may include at least one of the hollow body, an auxiliary window, and a depression.

In another embodiment, a fiber optic assembly includes a fiber optic connector including a connector housing and a ferrule extending therefrom and terminating at a ferrule end face. The fiber optic assembly also includes a fiber optic dust cap including a hollow body having a front end and a rear end and defining a bore extending therebetween, and a transparent window positioned over the bore. The connector housing is received by at least a first portion of the bore, at least a second portion of the bore is radially spaced apart from the ferrule, and the transparent window is longitudinally spaced apart from the ferrule. The ferrule end face may define a first plane and the transparent window may define a second plane parallel to the first plane. Alternatively, the ferrule end face may define a first plane and the transparent window may define a second plane oblique to the first plane. In one embodiment, the first portion of the bore frictionally engages the connector housing. In addition or alternatively, the fiber optic dust cap may include at least one additional translucent feature for allowing illumination of the ferrule end face therethrough. The fiber optic dust cap may include at least one auxiliary transparent or translucent feature for allowing illumination of the ferrule end face therethrough. For example, the at least one auxiliary transparent or translucent feature may include at least one of the hollow body, an auxiliary window, and a depression.

In yet another embodiment, a method is provided of inspecting an end face of a ferrule of a fiber optic connector through a dust cap seated on the fiber optic connector, the dust cap including a transparent window. The method includes positioning a visual inspection system adjacent to the transparent window on an exterior side thereof such that an imaging direction of the visual inspection system passes through the transparent window. The method also includes visualizing the end face of the ferrule through the transparent window along the imaging direction to generate an inspection image. The method further includes assessing the inspection image for indicia of contamination of the end face of the ferrule. The imaging direction may be perpendicular to the end face. In one embodiment, the imaging direction is perpendicular to the transparent window. In another embodiment, the imaging direction is oblique to the transparent window. Visualizing the end face of the ferrule may be performed while the fiber optic connector is held in place by a fixture. In embodiment, visualizing the end face of the ferrule includes illuminating the end face of the ferrule. For example, illuminating the end face of the ferrule may be performed non-coaxially relative to the imaging direction.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of an exemplary dust cap according to this disclosure, with the dust cap including a dust cap window.

FIG. 2 is a cross sectional view of the dust cap taken along section line 2-2 in FIG. 1, showing the dust cap mounted to a housing of a fiber optic connector.

FIG. 3 is a schematic view of an alternative dust cap mounted to a housing of another fiber optic connector, showing an alternative configuration of the dust cap window and showing a visual inspection system visualizing the ferrule end face through the window along an imaging direction and further showing an illumination system illuminating the ferrule end face through an auxiliary window non-coaxially relative to the imaging direction.

FIG. 4 is a schematic view of an alternative dust cap mounted to a housing of another fiber optic connector, showing an alternative configuration of the dust cap window and showing a visual inspection system visualizing the ferrule end face through the window along an imaging direction.

FIG. 5 is a schematic view of an alternative dust cap mounted to a housing of another fiber optic connector, showing an alternative configuration of the dust cap window and showing a visual inspection system visualizing the ferrule end face through the window along an imaging direction.

FIG. 6 is a schematic view of an alternative dust cap mounted to a housing of another fiber optic connector, showing an alternative configuration of the dust cap window and showing a visual inspection system visualizing the ferrule end face through the window along an imaging direction.

FIG. 7 is a schematic view of an alternative dust cap mounted to a housing of another fiber optic connector, showing an alternative configuration of the dust cap window and showing a visual inspection system visualizing the ferrule end face through the window along an imaging direction.

FIG. 8 is a schematic view of an alternative dust cap mounted to a housing of another fiber optic connector, showing an alternative configuration of the dust cap window and showing a visual inspection system visualizing the ferrule end face through the window along an imaging direction.

FIG. 9 is a schematic view of an alternative dust cap mounted to a housing of another fiber optic connector, showing an alternative configuration of the dust cap window and showing a visual inspection system visualizing the ferrule end face through the window along an imaging direction.

### DETAILED DESCRIPTION

Various embodiments will be further clarified by examples in the description below. In general, the description relates to dust caps having transparent windows, and which may be selectively coupled to connector housings of optical fiber connectors prior to installation of the optical fiber connectors. Although the examples shown in the figures involve dust caps for single fiber connectors (e.g., LC or SC-type connectors), the description may also be applicable to dust caps for multi-fiber connectors (e.g., multifiber push-on/pull-off (MPO) type connectors).

Also, in the description below and elsewhere in this disclosure, dust cap bores (or portions thereof) may be described as extending along respective longitudinal axes. References to “radial” or “longitudinal” are with respect to one of such axes (the axis in question will be clear from the context). Additionally, the transparent windows may be described as being “centered” or “laterally offset” relative to one of such axes. The former means a center of the window is on the longitudinal axis in question, whereas the latter means the center of the window is spaced from the longitudinal axis in question in a radial direction.

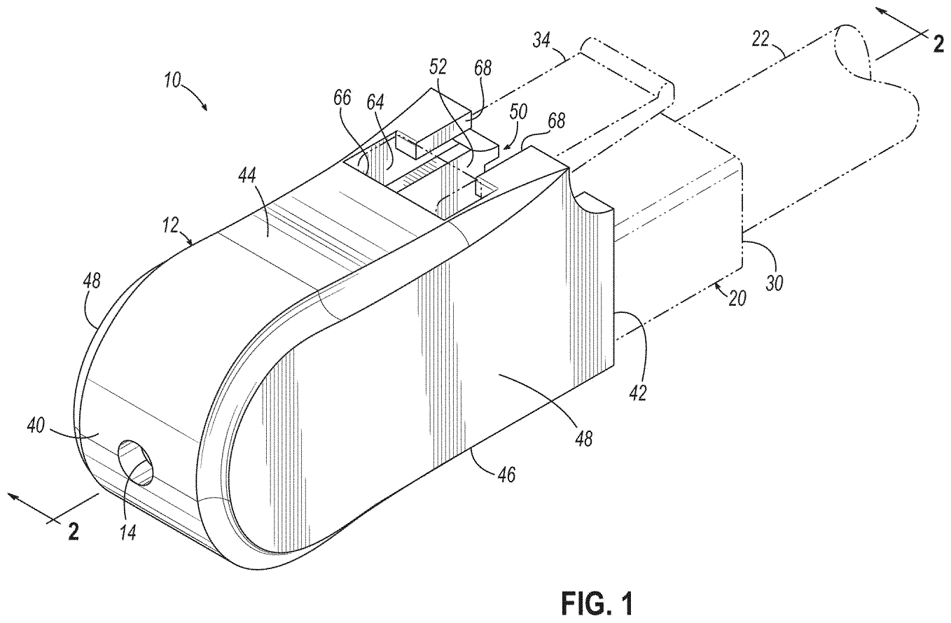

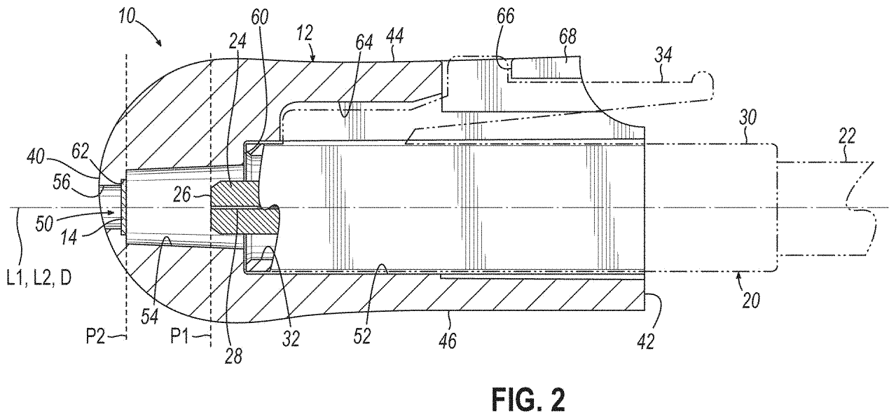

Referring now to FIGS. 1 and 2, the illustrated dust cap 10 includes a hollow body 12 and a transparent window 14. The hollow body 12 is configured to at least partially receive and frictionally engage a fiber optic connector, such as a physical contact (“PC”) or ultra-physical contact (“UPC”) connector 20 terminating a fiber optic cable 22. Such connectors 20 are well known and include a ferrule 24 having an end face 26 defining a reference plane P1 (generally perpendicular to a longitudinal axis L1 of the ferrule 24 for PC and UPC connectors) and a micro-hole 28 for receiving an optical fiber (not shown), a connector housing 30 having a bore 32 in which the ferrule 24 is received, and a latch arm 34 integrally formed with the connector housing 30. The hollow body 12 receives the connector 20 without directly contacting the ferrule 24 of the connector 20. As described in greater detail below, the transparent window 14 may allow visual inspection of the end face 26 of the ferrule 24 through the dust cap 10 such that the dust cap 10 may remain in place seated on the connector 20 during visual inspection of the end face 26 for contamination (e.g., along an imaging direction D generally perpendicular to the reference plane P1 defined by the end face 26). Such a design may be beneficial by eliminating the need to remove the dust cap 10 from the connector 20 during inspection and thus reducing the risk of inadvertently introducing contamination to the end face 26.

The illustrated hollow body 12 extends between a front end 40 and a rear end 42 and generally includes a top wall 44, a bottom wall 46, and a pair of side walls 48 collectively defining a multi-stage through-bore 50 (“multi-stage bore 50” or simply “bore 50”) for receiving the connector 20. As best shown in FIG. 2, the illustrated multi-stage through-bore 50 includes a retention bore 52 extending along a longitudinal axis L2 of the multi-stage bore 50 generally from the rear end 42 of the hollow body 12 toward the front end 40 of the hollow body 12 and being sized and shaped to receive and frictionally engage an outer surface of the connector housing 30. In this regard, the retention bore 52 may have an inner cross dimension approximately equal to (or just slightly larger than) an outer cross dimension of the connector housing 30.

The multi-stage through-bore 50 also includes a clearance bore 54 extending along the longitudinal axis L2 of the multi-stage bore 50 generally from the retention bore 52 toward the front end 40 of the hollow body 12 and being configured to accommodate the ferrule 24 protruding from the connector housing 30 when the connector housing 30 is received within the retention bore 52 without directly contacting the ferrule 24. In this regard, the clearance bore 54 may have an inner cross dimension substantially greater than an outer cross dimension of the ferrule 24. In the embodiment shown, the clearance bore 54 tapers radially inwardly from the retention bore 52 toward the front end 40 of the hollow body 12 such that clearance bore 54 has a varying inner cross dimension. Alternatively, the clearance bore 54 may have a constant inner cross dimension.

The multi-stage through-bore 50 further includes an inspection bore 56 extending along the longitudinal axis L2 of the multi-stage bore 50 generally from the clearance bore 54 to the front end 40 of the hollow body 12 for allowing visual inspection of the end face 26 of the ferrule 24 through the front end 40 when the dust cap 10 is seated on the connector housing 30. Thus, the retention, clearance, and inspection bores 52, 54, 56 of the illustrated multi-stage bore 50 are coaxial. In one embodiment, the inspection bore 56 may have an inner cross dimension sized to allow visual inspection of substantially the entire surface area of the end face 26 of the ferrule 24.

As shown, the clearance bore 54 may have an inner cross dimension substantially less than the inner cross dimension of the retention bore 52, such that a shoulder 60 is defined therebetween for mechanically engaging or abutting a front surface of the connector housing 30 and thereby limiting advancement of the connector housing 30 within the retention bore 52 from the rear end 42 toward the front end 40 along the longitudinal axis L2 thereof. In this manner, mechanical engagement between the shoulder 60 and the connector housing 30 may define a seated position of the dust cap 10 on the connector housing 30. As shown, the clearance bore 54 may have a length sufficiently great to ensure that the transparent window 14 is spaced apart from the end face 26 of the ferrule 24 to avoid direct contact between the transparent window 14 and the end face 26 and to allow visual inspection of substantially the entire surface area of the end face 26 through the transparent window 14 when the dust cap 10 is seated on the connector housing 30. In this regard, an annular recess 62 is provided between the clearance bore 54 and the inspection bore 56 for fixedly receiving the transparent window 14, as described in greater detail below.

With continuing reference primarily to FIG. 2, an auxiliary cavity 64 extends generally from the retention bore 52 toward the top wall 44 of the hollow body 12 and is configured to accommodate a portion of the connector 20, such as the latch arm 34 thereof, when the dust cap 10 is seated on the connector housing 30. A generally T-shaped opening 66 extends generally from the auxiliary cavity 64 to the top wall 44 of the hollow body 12 and is at least partially defined by a pair of opposed inwardly-extending flanges 68 provided in the top wall 44 of the hollow body 12, such that the opening 66 is configured to receive a portion of the latch arm 34 and the flanges 68 are configured to mechanically engage or abut the portion of the latch arm 34 received by the opening 66 to assist in preventing the dust cap 10 from becoming inadvertently dislodged from the connector housing 30.

The hollow body 12 may be constructed of any suitable material such as plastic, for example. In one embodiment, the hollow body 12 may be manufactured via one or more molding processes, such as an injection molding process. It should be recognized that any other suitable materials and/or processes may be used to construct the hollow body 12. In addition, the hollow body 12 may be sized and/or shaped to accommodate other types of connectors 20 than that shown.

As best shown in FIG. 2, the transparent window 14 is positioned over the inspection bore 56 and, more particularly, within the recess 62 between the clearance bore 54 and the inspection bore 56 to seal the clearance bore 54 from the exterior of the dust cap 10 so that the dust cap 10 may protect the end face 26 of the ferrule 24 from outside contamination when the dust cap 10 is seated on the connector housing 30, while also providing a generally unobstructed line of sight along the imaging direction D from a position forward of the front end 40 of the hollow body 12 to substantially the entire surface area of the end face 26 of the ferrule 24. In alternative embodiments, the clearance bore 54 and transparent window 14 may be shaped so that less surface area of the end face 26 can be seen by an inspection system (not shown in FIG. 2) setup with the imaging direction D. For example, the standard IEC 61300-3-35, Ed. 2.0, 2015-06 (“Fiber optic interconnecting devices and passive components—Basic test and measurement procedures”) describes methods for quantitatively assessing the end face quality of a polished fiber optic connector, and sets out cleanliness grading criteria in four different zones of a ferrule end face. The four zones (a core, cladding, adhesive, and contact zone) are a series of concentric circles that identify areas of interest on a connector end face. The outermost of the four zones defines or falls within a minimum field-of-view set out in the standard. The field-of-view can be as small as 250 μm (i.e., a circle with a diameter of 250 μm) for some types of fiber optic connectors. Thus, compliance with IEC 61300-3-35 may not require an unobstructed view along the imaging direction D to substantially the entire surface area of the end face 26 of the ferrule 24, and instead only that the dust cap 10 and inspection system (taking into account its positioning relative to the ferrule 24 and reception angle) be configured to meet the minimum field-of-view requirements (e.g., 250 μm). In this manner, the detected area of contamination of the ferrule end face 26 may not depend on the presence or absence of the dust cap 10.

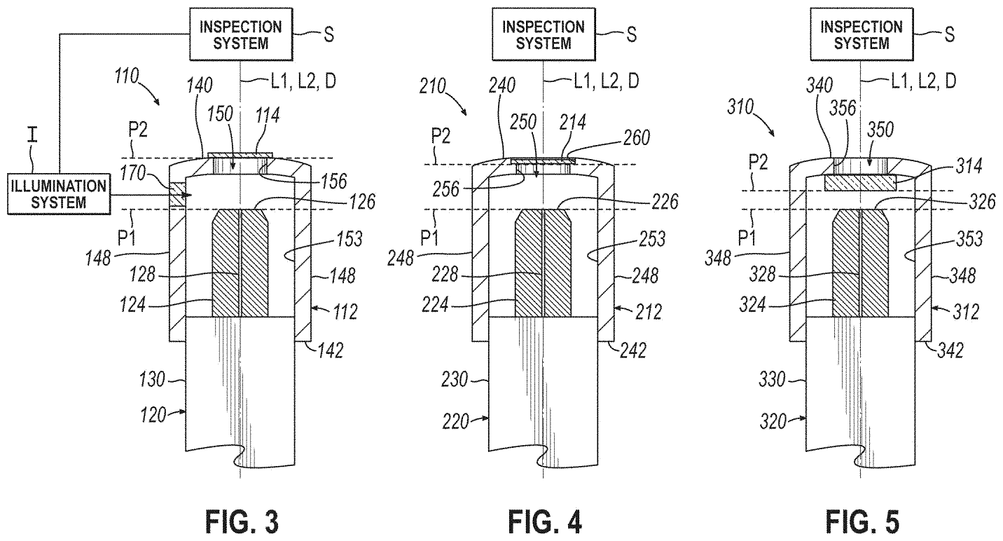

Still referring to FIG. 2, the transparent window 14 may be configured to provide excellent optical transmission, such as to avoid optical distortions of an image of the ferrule end face 26 when viewed therethrough and to avoid scattering light at the ferrule end face 26. For example, the transparent window 14 may be substantially flat or planar to define a plane P2 and may have substantially no warping and substantially no structural defects such as voids or cracks. In one embodiment, the surfaces of the transparent window 14 may be configured to avoid distorting the image of the ferrule end face 26 excessively and may provide minimal or no geometric distortion (e.g., barrel, pincushion, etc.), minimal or no magnification or demagnification, and minimal or no other distortions. In addition or alternatively, the surfaces of the transparent window 14 may be smooth and planar to avoid scattering, and may be substantially fully transparent to avoid absorption. In short, the transparent window 14 may be designed to have very little or no effect on the quality (e.g., sharpness, contrast, etc.) of an inspection image of the end face 26 of the ferrule 24 acquired by a visual inspection system S (FIGS. 3-9) in the imaging direction D. Furthermore, one or more anti-reflective coatings may be applied to the transparent window 14 to help ensure the quality of inspection images taken through the transparent window 14 are not degraded by undesirable reflections.

The transparent window 14 may be constructed of any suitable material such as glass or plastic, for example. In one embodiment, the transparent window 14 may be constructed of the same material as the hollow body 12 and may be manufactured via one or more molding processes, such as an injection molding process. For example, a two-shot molding process or an overmolding process may be used to integrally form the transparent window 14 together with the hollow body 12 (the latter being a unitary piece), or a one-shot molding process may be used to form the transparent window 14 and the hollow body 12 together as a unitary piece. Alternatively, the transparent window 14 and the hollow body 12 may be separately formed as distinct pieces, and the transparent window 14 may be inserted into the hollow body 12 and secured thereto. For example, the transparent window 14 be constructed of a mechanically-cut or laser-cut piece of plate glass and may be adhered to the annular recess 62 within the hollow body 12. In one embodiment, the transparent window 14 may have a minimized thickness to reduce the risk of optical distortions when visually inspecting the end face 26 of the ferrule 24 therethrough. For example, the thickness of the transparent window 14 may be approximately 0.17 mm.

As described above, the illustrated transparent window 14 is fixedly received by the annular recess 62. In this regard, the transparent window 14 may have an outer cross dimension approximately equal to an inner cross dimension of the annular recess 62 to provide an interference fit therebetween. In one embodiment, the outer cross dimension of the transparent window 14 (and thus the inner cross dimension of the annular recess 62) may be between approximately 2 mm and approximately 3 mm. For example, the outer cross dimension of the transparent window 14 may be at least 2 mm for LC PC connectors. In another embodiment, the outer cross dimension of the transparent window 14 may be at least 3 mm for LC angled physical contact (“APC”) connectors. It will be appreciated that the outer cross dimension of the transparent window 14 may vary depending on the type of connector, such as SC, MTP, etc.

In the embodiment shown, the plane P2 defined by the transparent window 14 is oriented generally perpendicular to the longitudinal axis L2 of the multi-stage bore 50, such that the plane P2 may likewise be oriented generally perpendicular to the longitudinal axis L2 of the ferrule 24 and thus generally parallel to the reference plane P1 defined by the end face 26 of the ferrule 24 when the dust cap 10 is seated on the connector housing 30. The transparent window 14 is also generally centered relative to the longitudinal axis L2 of the multi-stage bore 50 such that the transparent window 14 is coaxial with the multi-stage bore 50. As a result, the transparent window 14 may be generally axially aligned with the end face 26 of the ferrule 24 when the dust cap 10 is seated on the connector housing 30, and the imaging direction D of the visual inspection system S (FIGS. 3-9) may be generally perpendicular to the planes P1, P2 defined by both the transparent window 14 and the end face 26 of the ferrule 24.

As set forth above, the transparent window 14 and the clearance bore 54 are each spaced apart from the ferrule 24 when the dust cap 10 is seated on the connector housing 30. More particularly, the transparent window 14 is longitudinally spaced apart from the ferrule 24, and the clearance bore 54 is radially spaced apart from the ferrule 24 when the dust cap 10 is seated on the connector housing 30, such that substantially no portion of the dust cap 10 directly contacts any portion of the ferrule 24. Rather, the dust cap 10 contacts and couples to the connector housing 30. In this manner, when the dust cap 10 is seated on the connector housing 30 or unseated therefrom, the dust cap 10 may avoid introducing any contamination to the ferrule 24 and, more particularly, to the end face 26 thereof. For example, by avoiding direct contact with the side(s) of the ferrule 24, the dust cap 10 may reduce the risk of directly contacting and contaminating the end face 26 and may also reduce the risk of introducing contamination to the side(s) of the ferrule 24 which could subsequently travel to the end face 26. Moreover, relative movement of the dust cap 10 along the connector housing 30 during seating or unseating of the dust cap 10 may at most introduce contamination onto the connector housing 30 at a safe distance away from the end face 26 of the ferrule 24.

In addition, the transparent window 14 may allow visual inspection of the end face 26 of the ferrule 24 through the dust cap 10 by the visual inspection system S (FIGS. 3-9) along the imaging direction D such that the dust cap 10 may remain seated on the connector housing 30 during visual inspection of the end face 26, thereby eliminating the need to remove the dust cap 10 during inspection and thus reducing the risk of introducing contamination to the end face 26. For example, a visual inspection system S (FIGS. 3-9) may be positioned adjacent to the transparent window 14 on an exterior side thereof while the connector 20 is temporarily held in place by a fixture (not shown) with the dust cap 10 seated on the connector housing 30 such that the visual inspection system S may visualize the ferrule end face 26 through the transparent window 14 along the imaging direction D (e.g., via optical microscopy) to acquire an inspection image of the end face 26, which may then be assessed for contamination.

Referring now to FIG. 3, an alternative dust cap 110 including a hollow body 112 and a transparent window 114 defining a plane P2 is shown coupled to a PC or UPC connector 120 including a ferrule 124 having an end face 126 defining a reference plane P1 generally perpendicular to a longitudinal axis L1 of the ferrule 124 and a micro-hole 128 for receiving an optical fiber (not shown), and connector 120 includes a connector housing 130 in which the ferrule 124 is received. The hollow body 112 extends between front and rear ends 140, 142 and includes top and bottom walls (not shown) and a pair of side walls 148 at least partially defining a multi-stage through-bore 150 for receiving the connector 120. The illustrated multi-stage through-bore 150 includes a retention/clearance bore 153 extending along a longitudinal axis L2 of the multi-stage bore 150 generally from the rear end 142 of the hollow body 112 toward the front end 140 and is sized and shaped to receive and frictionally engage an outer surface of the connector housing 130. The multi stage through-bore 150 is further configured to accommodate the ferrule 124 protruding from the connector housing 130 when the dust cap 110 is seated on the connector housing 130 without directly contacting the ferrule 124. The multi-stage bore 150 also includes an inspection bore 156 extending along the longitudinal axis L2 of the multi-stage bore 150 generally from the retention/clearance bore 153 to the front end 140 of the hollow body 112 for allowing visual inspection of the end face 126 through the front end 140 when the dust cap 110 is seated on the connector housing 130. Similar to the embodiment described above with respect to FIGS. 1 and 2, the transparent window 114 is generally centered relative to and oriented generally perpendicular to the longitudinal axis L2 of the multi-stage bore 150 (e.g., coaxial with the multi-stage bore 150), such that the transparent window 114 may be oriented generally parallel to the reference plane P1 defined by the end face 126 of the ferrule 124 and axially aligned therewith when the dust cap 110 is seated on the connector housing 130 to allow visual inspection of the end face 126 of the ferrule 124 along the imaging direction D of the visual inspection system S (FIGS. 3-9) generally perpendicular to the reference plane P1 defined by the end face 126 of the ferrule 124.

In the embodiment shown, the transparent window 114 is fixedly attached (e.g., adhered) to the front end 140 of the hollow body 112 over the inspection bore 156. As a result, the transparent window 114 may be spaced relatively farther away from the end face 126 of the ferrule 124 when the dust cap 110 is seated on the connector housing 130 in comparison to the embodiment shown in FIGS. 1 and 2.

Referring now to FIG. 4, an alternative dust cap 210 including a hollow body 212 and a transparent window 214 defining a plane P2 is shown coupled to a PC or UPC connector 220 including a ferrule 224 having an end face 226 defining a reference plane P1 generally perpendicular to a longitudinal axis L1 of the ferrule 224 and a micro-hole 228 for receiving an optical fiber (not shown), and a connector housing 230 in which the ferrule 224 is received. The hollow body 212 extends between front and rear ends 240, 242 and includes top and bottom walls (not shown) and a pair of side walls 248 at least partially defining a multi-stage through-bore 250 for receiving the connector 220. The illustrated multi-stage through-bore 250 includes a retention/clearance bore 253 extending along a longitudinal axis L2 of the multi-stage bore 250 generally from the rear end 242 of the hollow body 212 toward the front end 240 and being sized and shaped to receive and frictionally engage an outer surface of the connector housing 230. The multi-stage through-bore 250 is further configured to accommodate the ferrule 224 protruding from the connector housing 230 when the dust cap 210 is seated on the connector housing 230 without directly contacting the ferrule 224. The multi-stage bore 250 also includes an inspection bore 256 extending along the longitudinal axis L2 of the multi-stage bore 250 generally from the retention/clearance bore 253 to the front end 240 of the hollow body 212 for allowing visual inspection of the end face 226 through the front end 240 when the dust cap 210 is seated on the connector housing 230. Similar to the embodiment described above with respect to FIGS. 1 and 2, the transparent window 214 is generally centered relative to and oriented generally perpendicular to the longitudinal axis L2 of the multi-stage bore 250 (e.g., coaxial with the multi-stage bore 250), such that the transparent window 214 may be oriented generally parallel to the reference plane P1 defined by the end face 226 of the ferrule 224 and axially aligned therewith when the dust cap 210 is seated on the connector housing 230 to allow visual inspection of the end face 226 of the ferrule 224 along the imaging direction D of the visual inspection system S generally perpendicular to the reference plane P1 defined by the end face 226 of the ferrule 224.

In the embodiment shown, the transparent window 214 is received within and fixedly attached (e.g., adhered) to a recess 260 provided between the inspection bore 256 and the front end 240 of the hollow body 212 over the inspection bore 256. As a result, the transparent window 214 is spaced relatively closer to the end face 226 of the ferrule 224 when the dust cap 210 is seated on the connector housing 230 in comparison to the embodiment shown in FIG. 3. Nevertheless, the transparent window 214 is spaced sufficiently far apart from the end face 226 of the ferrule 224 to avoid contact therewith.

Referring now to FIG. 5, an alternative dust cap 310 including a hollow body 312 and a transparent window 314 defining a plane P2 is shown coupled to a PC or UPC connector 320 including a ferrule 324 having an end face 326 defining a reference plane P1 generally perpendicular to a longitudinal axis L1 of the ferrule 324 and a micro-hole 328 for receiving an optical fiber (not shown), and a connector housing 330 in which the ferrule 324 is received. The hollow body 312 extends between front and rear ends 340, 342 and includes top and bottom walls (not shown) and a pair of side walls 348 at least partially defining a multi-stage through-bore 350 for receiving the connector 320. The illustrated multi-stage through-bore 350 includes a retention/clearance bore 353 extending along a longitudinal axis L2 of the multi-stage through-bore 350 generally from the rear end 342 of the hollow body 312 toward the front end 340 and being sized and shaped to receive and frictionally engage an outer surface of the connector housing 330. The multi-stage through-bore 350 is further configured to accommodate the ferrule 324 protruding from the connector housing 330 when the dust cap 310 is seated on the connector housing 330 without directly contacting the ferrule 324. The multi-stage through-bore 350 also includes an inspection bore 356 extending along the longitudinal axis L2 of the multi-stage through-bore 350 generally from the retention/clearance bore 353 to the front end 340 of the hollow body 312 for allowing visual inspection of the end face 326 through the front end 340 when the dust cap 310 is seated on the connector housing 330. Similar to the embodiment described above with respect to FIGS. 1 and 2, the transparent window 314 is generally centered relative to and oriented generally perpendicular to the longitudinal axis L2 of the multi-stage through-bore 350 (e.g., coaxial with the multi-stage through-bore 350), such that the transparent window 314 may be oriented generally parallel to the reference plane P1 defined by the end face 326 of the ferrule 324 and axially aligned therewith when the dust cap 310 is seated on the connector housing 330 to allow visual inspection of the end face 326 of the ferrule 324 along the imaging direction D of the visual inspection system S generally perpendicular to the reference plane P1 defined by the end face 326 of the ferrule 324.

In the embodiment shown, the transparent window 314 is substantially thicker than those described above with respect to FIGS. 1-4. The transparent window 314 is also fixedly attached (e.g., adhered) to an inner surface of the hollow body 312 under the inspection bore 356 without being received in any corresponding recess (cf. recess 62). As a result, the transparent window 314 may be spaced relatively closer to the end face 326 of the ferrule 324 when the dust cap 310 is seated on the connector housing 330 in comparison to the embodiments shown in FIGS. 1-4. Nevertheless, the transparent window 314 is spaced sufficiently far apart from the end face 326 of the ferrule 324 to avoid contact therewith.

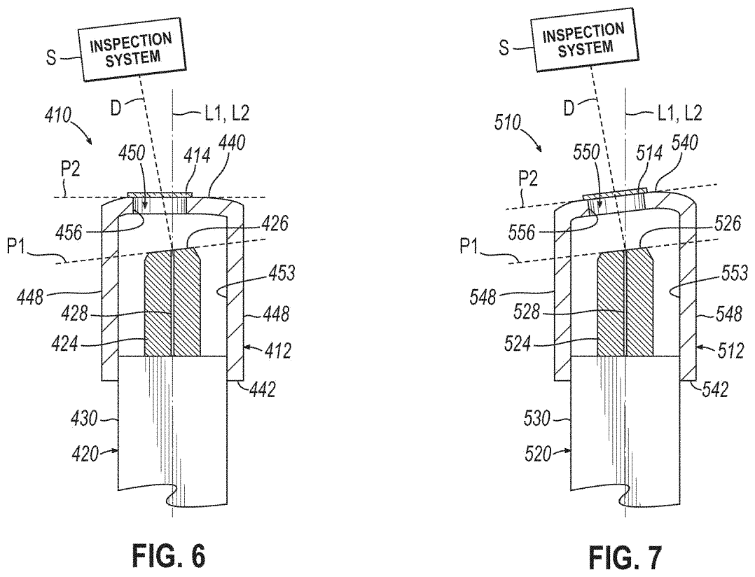

Referring now to FIG. 6, an alternative dust cap 410 including a hollow body 412 and a transparent window 414 defining a plane P2 is shown coupled to an APC connector 420 including a ferrule 424 and a connector housing 430 in which the ferrule 424 is received. The ferrule 424 has an end face 426 defining a reference plane P1 slightly oblique (e.g., angled between approximately 8° and approximately 9°) relative to a plane that is perpendicular to the longitudinal axis L1 of the ferrule 424 and a micro-hole 428 for receiving an optical fiber (not shown). The hollow body 412 extends between front and rear ends 440, 442 and includes top and bottom walls (not shown) and a pair of side walls 448 at least partially defining a multi-stage through-bore 450 for receiving the connector 420. The illustrated multi-stage through-bore 450 includes a retention/clearance bore 453 extending along a longitudinal axis L2 of the multi-stage through-bore 450 generally from the rear end 442 of the hollow body 412 toward the front end 440 and being sized and shaped to receive and frictionally engage an outer surface of the connector housing 430. This engagement also prevents rotation of the dust cap 410 relative to the connector 420. The multi-stage through-bore 450 is further configured to accommodate the ferrule 424 protruding from the connector housing 430 when the dust cap 410 is seated on the connector housing 430 without directly contacting the ferrule 424. The multi-stage through-bore 450 also includes an inspection bore 456 extending parallel to the longitudinal axis L2 of the multi-stage through-bore 450 generally from the retention/clearance bore 453 to the front end 440 of the hollow body 412 for allowing visual inspection of the end face 426 through the front end 440 when the dust cap 410 is seated on the connector housing 430. Similar to the embodiment described above with respect to FIG. 3, the transparent window 414 is fixedly attached (e.g., adhered) to the front end 440 of the hollow body 412 over the inspection bore 456 and is oriented generally perpendicular to the longitudinal axis L2 of the multi-stage through-bore 450.

In the embodiment shown, the inspection bore 456 and transparent window 414 are each laterally offset from the longitudinal axis L2 of the retention/clearance bore 453 (e.g., non-coaxial with the retention/clearance bore 453) to accommodate for the slight angling of the reference plane P1 defined by the end face 426 of the ferrule 424 relative to a plane that is perpendicular to the longitudinal axis L1 of the ferrule 424. In this regard, while the transparent window 414 is slightly oblique relative to the reference plane P1 defined by the end face 426 of the ferrule 424 and is non-coaxial therewith (i.e. not aligned along the longitudinal axis L1) when the dust cap 410 is seated on the connector housing 430, the particular amount of lateral offset of the inspection bore 456 and transparent window 414 from the longitudinal axis L2 of the retention/clearance bore 453 may be selected to allow visual inspection along the imaging direction D of the visual inspection system S (with D being generally perpendicular to the reference plane P1) of an area sufficient to meet field-of-view requirements of the standard IEC 61300-3-35, Ed. 2.0, 2015-06. In some embodiments, the amount of lateral offset and size of the inspection bore 456 and transparent window 414 may be selected to allow visual inspection of substantially the entire surface area of the end face 426 of the ferrule 424 along the imaging direction D of the visual inspection system S.

Referring now to FIG. 7, an alternative dust cap 510 including a hollow body 512 and a transparent window 514 defining a plane P2 is shown coupled to an APC connector 520 including a ferrule 524 having an end face 526 defining a reference plane P1 slightly oblique (e.g., angled between approximately 8° and approximately 9°) relative to a plane that is perpendicular to the longitudinal axis L1 of the ferrule 524 and a micro-hole 528 for receiving an optical fiber (not shown), and a connector housing 530 in which the ferrule 524 is received. The hollow body 512 extends between front and rear ends 540, 542 and includes top and bottom walls (not shown) and a pair of side walls 548 at least partially defining a multi-stage through-bore 550 for receiving the connector 520. The illustrated multi-stage through-bore 550 includes a retention/clearance bore 553 extending along a longitudinal axis L2 of the multi-stage through-bore 550 generally from the rear end 542 of the hollow body 512 toward the front end 540 and being sized and shaped to receive and frictionally engage an outer surface of the connector housing 530. This engagement also prevents rotation of the dust cap 510 relative to the connector 520. The multi-stage through-bore 550 is further configured to accommodate the ferrule 524 protruding from the connector housing 530 when the dust cap 510 is seated on the connector housing 530 without directly contacting the ferrule 524. The multi-stage through-bore 550 also includes an inspection bore 556 extending at an angle relative to the longitudinal axis L2 of the multi-stage through-bore 550 generally from the retention/clearance bore 553 to the front end 540 of the hollow body 512 for allowing visual inspection of the end face 526 through the front end 540 when the dust cap 510 is seated on the connector housing 530. Similar to the embodiment described above with respect to FIG. 3, the transparent window 514 is fixedly attached (e.g., adhered) to the front end 540 of the hollow body 512 over the inspection bore 556. Alternatively, the transparent window 514 may be fixedly attached to the hollow body 512 in any other suitable configuration, such as any of the other configurations described above.

In the embodiment shown, the inspection bore 556 and transparent window 514 are each laterally and angularly offset from the longitudinal axis L2 of the retention/clearance bore 553 (e.g., non-coaxial with the retention/clearance bore 553) to accommodate for the slight angling of the reference plane P1 defined by the end face 526 of the ferrule 524 relative to a plane that is perpendicular to the longitudinal axis L1 of the ferrule 524. In this regard, the particular amount of lateral offset and/or degree of angular offset of the inspection bore 556 and transparent window 514 may be selected such that the transparent window 514 may be oriented generally parallel to the reference plane P1 defined by the end face 526 of the ferrule 524 and axially aligned therewith when the dust cap 510 is seated on the connector housing 530 to allow visual inspection along the imaging direction D of the visual inspection system S (with D being generally perpendicular to the reference plane P1) of an area sufficient to meet field-of-view requirements of the standard IEC 61300-3-35, Ed. 2.0, 2015-06. In some embodiments, the lateral offset, angular offset, and size of the inspection bore 556 and transparent window 514 may be selected to allow visual inspection of substantially the entire surface area of the end face 526 of the ferrule 524 along the imaging direction D of the visual inspection system S.

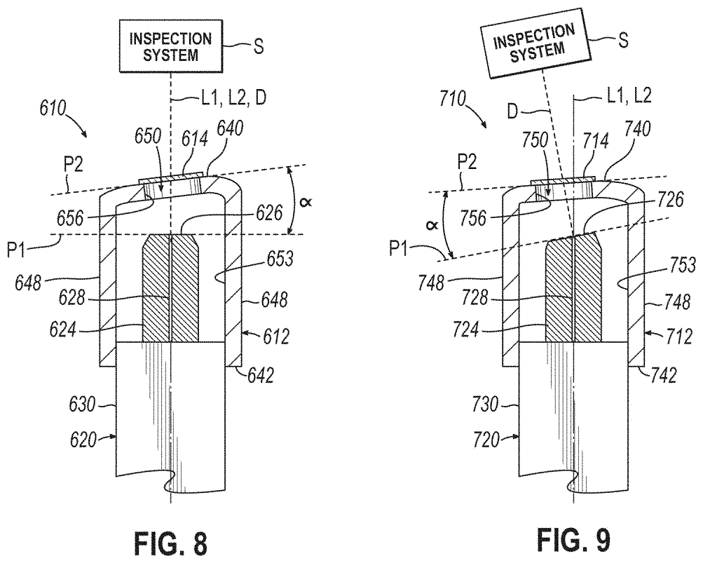

Referring now to FIG. 8, an alternative dust cap 610 including a hollow body 612 and a transparent window 614 defining a plane P2 is shown coupled to a PC connector 620 including a ferrule 624 having an end face 626 defining a reference plane P1 generally perpendicular to a longitudinal axis L1 of the ferrule 624 and a micro-hole 628 for receiving an optical fiber (not shown), and a connector housing 630 in which the ferrule 624 is received. The hollow body 612 extends between front and rear ends 640, 642 and includes top and bottom walls (not shown) and a pair of side walls 648 at least partially defining a multi-stage through-bore 650 for receiving the connector 620. The illustrated multi-stage through-bore 650 includes a retention/clearance bore 653 extending along a longitudinal axis L2 of the multi-stage through-bore 650 generally from the rear end 642 of the hollow body 612 toward the front end 640 and being sized and shaped to receive and frictionally engage an outer surface of the connector housing 630. The multi-stage through-bore 650 is further configured to accommodate the ferrule 624 protruding from the connector housing 630 when the dust cap 610 is seated on the connector housing 630 without directly contacting the ferrule 624. The multi-stage through-bore 650 also includes an inspection bore 656 extending at an angle relative to the longitudinal axis L2 of the multi-stage through-bore 650 generally from the retention/clearance bore 653 to the front end 640 of the hollow body 612 for allowing visual inspection of the end face 626 through the front end 640 when the dust cap 610 is seated on the connector housing 630. Similar to the embodiment described above with respect to FIG. 3, the transparent window 614 is fixedly attached (e.g., adhered) to the front end 640 of the hollow body 612 over the inspection bore 656. Alternatively, the transparent window 614 may be fixedly attached to the hollow body 612 in any other suitable configuration, such as any of the other configurations described above.

In the embodiment shown, the inspection bore 656 and transparent window 614 are each angularly offset from the longitudinal axis L2 of the retention/clearance bore 653 (e.g., non-coaxial with the retention/clearance bore 653) such that the transparent window 614 may be slightly oblique relative to the reference plane P1 defined by the end face 626 of the ferrule 624 when the dust cap 610 is seated on the connector housing 630. In this regard, an exactly parallel orientation of the transparent window 614 relative to the reference plane P1 defined by the end face 626 of the ferrule 624 may result in undesirable reflections (e.g., specular reflections) which may degrade the quality of an inspection image of the end face 626 of the ferrule 624 acquired in the imaging direction D of the visual inspection system S generally perpendicular to the end face 626. Thus, an angular offset a of the transparent window 614 relative to the reference plane P1 defined by the end face 626 of the ferrule 624 may reduce or avoid such reflections. In one embodiment, an angular offset a of the transparent window 614 relative to the reference plane P1 defined by the end face 626 of the ferrule 624 of at least half of the full reception angle of the visual inspection system may be used to avoid such reflections. For example, the angular offset a may be at least approximately 4.5° for use with a visual inspection system having a full reception angle of approximately 9°. In one embodiment, the angular offset a may be approximately 5° for use with such a visual inspection system.

Referring now to FIG. 9, an alternative dust cap 710 including a hollow body 712 and a transparent window 714 defining a plane P2 is shown coupled to an APC connector 720 including a ferrule 724 having an end face 726 defining a reference plane P1 slightly oblique (e.g., angled between approximately 8° and approximately 9°) relative to a plane that is perpendicular to the longitudinal axis L1 of the ferrule 724 and a micro-hole 728 for receiving an optical fiber (not shown), and a connector housing 730 in which the ferrule 724 is received. The hollow body 712 extends between front and rear ends 740, 742 and includes top and bottom walls (not shown) and a pair of side walls 748 at least partially defining a multi-stage through-bore 750 for receiving the connector 720. The illustrated multi-stage through-bore 750 includes a retention/clearance bore 753 extending along a longitudinal axis L2 of the multi-stage through-bore 750 generally from the rear end 742 of the hollow body 712 toward the front end 740 and being sized and shaped to receive and frictionally engage an outer surface of the connector housing 730. This engagement also prevents rotation of the dust cap 710 relative to the connector 720. The multi-stage through-bore 750 further configured to accommodate the ferrule 724 protruding from the connector housing 730 when the dust cap 710 is seated on the connector housing 730 without directly contacting the ferrule 724. The multi-stage through-bore 750 also includes an inspection bore 756 extending at an angle relative to the longitudinal axis L2 of the multi-stage through-bore 750 generally from the retention/clearance bore 753 to the front end 740 of the hollow body 712 for allowing visual inspection of the end face 726 through the front end 740 when the dust cap 710 is seated on the connector housing 730. Similar to the embodiment described above with respect to FIG. 3, the transparent window 714 is fixedly attached (e.g., adhered) to the front end 740 of the hollow body 712 over the inspection bore 756. Alternatively, the transparent window 714 may be fixedly attached to the hollow body 712 in any other suitable configuration, such as any of the other configurations described above.

In the embodiment shown, the inspection bore 756 and transparent window 714 are each laterally and angularly offset from the longitudinal axis L2 of the retention/clearance bore 753 (e.g., non-coaxial with the retention/clearance bore 753) such that the transparent window 714 may be slightly oblique relative to the reference plane P1 defined by the end face 726 of the ferrule 724 when the dust cap 710 is seated on the connector housing 730. As described above, an exactly parallel orientation of the transparent window 714 relative to the reference plane P1 defined by the end face 726 of the ferrule 724 may result in undesirable reflections which may degrade the quality of an inspection image of the end face 726 of the ferrule 724 acquired in the imaging direction D of the visual inspection system S generally perpendicular to the end face 726. Thus, an angular offset a of the transparent window 714 relative to the reference plane P1 defined by the end face 726 of the ferrule 724 may reduce or avoid such reflections. In one embodiment, an angular offset a of the transparent window 714 relative to the reference plane P1 defined by the end face 726 of the ferrule 724 of at least half of the full reception angle of the visual inspection system may be used to avoid such reflections. For example, the angular offset a may be at least approximately 4.5° for use with a visual inspection system having a full reception angle of approximately 9°. In one embodiment, the angular offset a may be approximately 5° for use with such a visual inspection system.

Thus, each of the exemplary dust caps 10, 110, 210, 310, 410, 510, 610, 710 may reduce the risk of contaminating the respective ferrule end face 26, 126, 226, 326, 426, 526, 626, 726 by avoiding direct contact therewith and instead contacting and coupling to the connector housing 30, 130, 230, 330, 430, 530, 630, 730, and by remaining seated thereon during visual inspection of the ferrule end face 26, 126, 226, 326, 426, 526, 626, 726 through the respective transparent window 14, 114, 214, 314, 414, 514, 614, 714.

While the illustrated dust caps 10, 110, 210, 310, 410, 510, 610, 710 are shown seated on connectors 20, 120, 220, 320, 420, 520, 620, 720 each having only a single ferrule 24, 124, 224, 324, 424, 524, 624, 724, it will be appreciated that the dust caps 10, 110, 210, 310, 410, 510, 610, 710 may be seated on multifiber and/or multi-ferrule connectors (not shown). In one embodiment, the transparent window 14, 114, 214, 314, 414, 514, 614, 714 may be enlarged to allow visual inspection of substantially the entire surface area of the ferrule end faces of such multi-ferrule connectors along the imaging direction. In another embodiment, multiple transparent windows (not shown) corresponding to the multiple ferrule end faces may be incorporated into the dust cap.

As shown in FIG. 3, an illumination system I configured to illuminate the ferrule end face 26, 126, 226, 326, 426, 526, 626, 726 during visual inspection thereof may be in operative communication with the inspection system S. In some embodiments, the dust cap 10, 110, 210, 310, 410, 510, 610, 710 may include one or more auxiliary transparent and/or translucent features to assist in the illumination of the ferrule end face 26, 126, 226, 326, 426, 526, 626, 726 by a light source (e.g., free space light source, fiber bundle, light pipe, etc.) of the illumination system I, such as for allowing oblique or otherwise non-coaxial (e.g., relative to the imaging direction D) illumination thereof. For example, the hollow body 12, 112, 212, 312, 412, 512, 612, 712 may be substantially entirely constructed of a transparent and/or translucent material for allowing light to pass therethrough from the illumination system I to the ferrule end face 26, 126, 226, 326, 426, 526, 626, 726. In one embodiment, the hollow body 12, 112, 212, 312, 412, 512, 612, 712 may include one or more rough surfaces and/or scattering fillers to assist in producing a homogenous illumination of the ferrule end face 26, 126, 226, 326, 426, 526, 626, 726.

In another embodiment, the dust cap 10, 110, 210, 310, 410, 510, 610, 710 may include one or more auxiliary transparent and/or translucent windows 170 (FIG. 3) in addition to the transparent window 14, 114, 214, 314, 414, 514, 614, 714 positioned on or through the hollow body 12, 112, 212, 312, 412, 512, 612, 712 (e.g., molded therein) to allow direct or other illumination of the ferrule end face 26, 126, 226, 326, 426, 526, 626, 726 therethrough by the illumination system I. Such auxiliary windows may have surfaces and other optical characteristics similar to or different from the surfaces and other optical characteristics of the transparent window 14, 114, 214, 314, 414, 514, 614, 714. The dust cap 10, 110, 210, 310, 410, 510, 610, 710 may also include one or more lenses (e.g., rough, Fresnel, etc.) for directing light from a side of the hollow body 12, 112, 212, 312, 412, 512, 612, 712 onto the ferrule end face 26, 126, 226, 326, 426, 526, 626, 726.

In one embodiment, the dust cap 10, 110, 210, 310, 410, 510, 610, 710 may include one or more features such as depressions (e.g., molded therein) configured to accept a fiber bundle or a light pipe from the illumination system I to assist in illuminating and/or inspecting the ferrule end face 26, 126, 226, 326, 426, 526, 626, 726. In addition or alternatively, the dust cap 10, 110, 210, 310, 410, 510, 610, 710 may include one or more mechanical features configured to latch onto or otherwise selectively couple to the illumination system I and/or the visual inspection system S for preventing relative movement therebetween during illumination and/or visual inspection of the ferrule end face 26, 126, 226, 326, 426, 526, 626, 726.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

1. A fiber optic dust cap for a fiber optic connector having a connector housing and a ferrule extending therefrom and terminating at a ferrule end face, the fiber optic dust cap comprising:
a hollow body including a front end and a rear end and defining a bore extending therebetween, wherein at least a first portion of the bore extends along a longitudinal axis and is configured to receive the connector housing and at least a second portion of the bore is configured to be radially spaced apart from the ferrule when the connector housing is received by at least the first portion of the bore; and
a transparent window positioned over the bore and configured to be longitudinally spaced apart from the ferrule when the connector housing is received by at least the first portion of the bore.

2. The fiber optic dust cap of claim 1, wherein the transparent window defines a plane.

3. The fiber optic dust cap of claim 2, wherein the plane defined by the transparent window is perpendicular to the longitudinal axis.

4. The fiber optic dust cap of claim 3, wherein the transparent window is centered relative to the longitudinal axis such that the transparent window is coaxial with at least the first portion of the bore.

5. The fiber optic dust cap of claim 2, wherein the plane defined by the transparent window is oblique to the longitudinal axis to define an angular offset of the transparent window.

6. The fiber optic dust cap of claim 1, wherein the transparent window is laterally offset from the longitudinal axis.

7. The fiber optic dust cap of claim 1, wherein the plane defined by the transparent window is configured to be parallel to a reference plane defined by the ferrule end face when the connector housing is received by at least the first portion of the bore.

8. The fiber optic dust cap of claim 1, wherein the plane defined by the transparent window is configured to be oblique to a reference plane defined by the ferrule end face when the connector housing is received by at least the first portion of the bore.

9. The fiber optic dust cap of claim 1, wherein the first portion of the bore has a first cross dimension and the second portion of the bore has a second cross dimension less than the first cross dimension such that a shoulder is defined between the first and second portions of the bore, and wherein the shoulder is configured to mechanically engage the connector housing to define a seated position of the fiber optic dust cap on the fiber optic connector.

10. The fiber optic dust cap of claim 1, wherein the transparent window comprises glass.

11. The fiber optic dust cap of claim 1, further comprising:
at least one auxiliary transparent or translucent feature for allowing illumination of the ferrule end face therethrough.

12. The fiber optic dust cap of claim 11, wherein the at least one auxiliary transparent or translucent feature includes a hollow body, an auxiliary window, or a depression.

13. A fiber optic assembly comprising:
a fiber optic connector including a connector housing and a ferrule extending therefrom and terminating at a ferrule end face; and
a fiber optic dust cap including a hollow body having a front end and a rear end and defining a bore extending therebetween, and a transparent window positioned over the bore,
wherein the connector housing is received by at least a first portion of the bore, at least a second portion of the bore is radially spaced apart from the ferrule, and the transparent window is longitudinally spaced apart from the ferrule.

14. The fiber optic assembly of claim 13, wherein the ferrule end face defines a first plane and the transparent window defines a second plane parallel to the first plane.

15. The fiber optic assembly of claim 13, wherein the ferrule end face defines a first plane and the transparent window defines a second plane oblique to the first plane.

16. The fiber optic assembly of claim 13, wherein the first portion of the bore frictionally engages the connector housing.

17. The fiber optic assembly of claim 13, wherein the fiber optic dust cap includes at least one auxiliary transparent or translucent feature for allowing illumination of the ferrule end face therethrough.

18. The fiber optic assembly of claim 17, wherein the at least one auxiliary transparent or translucent feature includes a hollow body, an auxiliary window, or a depression.

19. A method of inspecting an end face of a ferrule of a fiber optic connector through a dust cap seated on the fiber optic connector, the dust cap including a transparent window, the method comprising:
positioning a visual inspection system adjacent to the transparent window on an exterior side thereof such that an imaging direction of the visual inspection system passes through the transparent window;
visualizing the end face of the ferrule through the transparent window along the imaging direction to generate an inspection image; and
assessing the inspection image for indicia of contamination of the end face of the ferrule.

20-25. (canceled)
